(19) United States
(12) Patent Application Publication
(10) Pub. No.: US 2023/0080973 A1
(43) Pub. Date: Mar. 16, 2023

(54) DATA PROCESSING APPARATUS, DATA PROCESSING SYSTEM, AND DATA PROCESSING METHOD

(71) Applicant: NEC Corporation, Minato-ku, Tokyo (JP)

(72) Inventors: Jiro ABE, Tokyo (JP); Akira TSUJI, Tokyo (JP); Junichi ABE, Tokyo (JP); Yoshimasa ONO, Tokyo (JP); Shigeo SUZUKI, Tokyo (JP); Hiroshi MATSUMOTO, Tokyo (JP); Takanori SHIGETA, Tokyo (JP); Taisuke TANABE, Tokyo (JP)

(73) Assignee: NEC Corporation, Minato-ku, Tokyo (JP)

(21) Appl. No.: 17/801,331

(22) PCT Filed: Mar. 10, 2020
(86) PCT No.: PCT/JP2020/010332

§ 371 Date: Aug. 22, 2022

(51) Int. Cl. G01B 11/24

(52) U.S. Cl. CPC G01B 11/24

(57) ABSTRACT

There are provided a data processing apparatus, a data processing system, and a data processing method that can improve convenience of display of point group data. A data processing apparatus (1) includes a point group data processing unit (10) configured to display, when a viewpoint for display of point group data obtained by scanning a display object is input, the point group data viewed from the viewpoint, and an image data processing unit (20) configured to determine image data corresponding to the point group data to be displayed, from a plurality of pieces of image data obtained by imaging the display object from different positions, and to display the determined image data.

### TECHNICAL FIELD

The present invention relates to a data processing apparatus, a data processing system, and a data processing method.

### BACKGROUND ART

As a method to display a site that includes industrial facilities/equipment, common structures, a natural environment, and the like as a display object, for example, LiDAR (Light Detection and Ranging) is used. The LiDAR can acquire a shape of an object as point group data by scanning the object with irradiation light. For example, a principle of ToF (Time of Flight) LiDAR is as follows. The LiDAR includes a light emission unit emitting the irradiation light, and a detection unit detecting reflected light that is the irradiation light reflected by the object. The LiDAR detects the reflected light reflected by the object while scanning the object with the irradiation light at a predetermined angle of view. Further, the LiDAR calculates a distance D to the object from an expression D=(t2−t1)/2×(light velocity) by using a time t1 until the irradiation light reaches the object and a time t2 until the reflected light reaches the detection unit. As a result, the LiDAR can acquire the point group data including the distance to the object as scan data in a scanned range.

For example, Non-Patent Literature 1 discloses that RGB information acquired by a camera is imparted to each point of the point group data.

### CITATION LIST

### Non-Patent Literature

Non-Patent Literature 1: “FARO 3D Digital Documentation Software for Terrestrial Laser Scanner and Hand Scanner”, SCENE 2019, [online], [searched on Feb. 21, 2020], Internet <URL: http://www.faro.com/ja-jp/products/3d-design/faro-scene>

### SUMMARY OF INVENTION

### Technical Problem

In display disclosed in Non-Patent Literature 1, each point of the point group data is colored based on the RGB information. Therefore, positional information, for example, coloring with a specific color to enhance an abnormal position in an inspection result cannot be imparted. Further, in the display disclosed in Non-Patent Literature 1, it is not possible to acquire color information on a position such as a far place or sky where reflected light is not acquirable because the irradiation light does not reach and point group data is not acquirable. As described above, the display of the point group data disclosed in Non-Patent Literature 1 has an issue in terms of convenience.

The present disclosure is made to solve such issues, and an objective of the present disclosure is to provide a data processing apparatus, a data processing system, and a data processing method that can improve convenience of display of point group data.

### Solution to Problem

A data processing apparatus according to the present disclosure includes a point group data processing means configured to display, when a viewpoint for display of point group data obtained by scanning a site is input, the point group data viewed from the viewpoint, and an image data processing means configured to determine image data corresponding to the point group data to be displayed, from a plurality of pieces of image data obtained by imaging the site from different positions, and to display the determined image data.

A data processing system according to the present disclosure includes the above-described data processing apparatus, and a point group data acquisition means configured to acquire the point group data.

A data processing method according to the present disclosure includes a point group data display step of displaying, when a viewpoint for display of point group data obtained by scanning a site is input, the point group data viewed from the viewpoint, and an image data display step of determining image data corresponding to the point group data to be displayed, from a plurality of pieces of image data obtained by imaging the site from different positions, and displaying the determined image data.

### Advantageous Effects of Invention

According to the present disclosure, it is possible to provide the data processing apparatus, the data processing system, and the data processing method that can improve convenience of display of the point group data.

### BRIEF DESCRIPTION OF DRAWINGS

FIG. 1 is a diagram illustrating an outline of a data processing apparatus according to an example embodiment;

FIG. 2 is a diagram illustrating point group data displayed by a point group data processing unit in the data processing apparatus according to the example embodiment;

FIG. 3 is a diagram illustrating image data displayed by an image data processing unit in the data processing apparatus according to the example embodiment;

FIG. 4 is a diagram illustrating point group data displayed by the point group data processing unit in a case where a viewpoint is moved, in the data processing apparatus according to the example embodiment;

FIG. 5 is a diagram illustrating image data displayed by the image data processing unit in the case where the viewpoint is moved, in the data processing apparatus according to the example embodiment;

FIG. 6 is a configuration diagram illustrating a data processing apparatus according to a first example embodiment;

FIG. 7 is a diagram illustrating a structure map and structure data held by a site map holding unit in the data processing apparatus according to the first example embodiment;

FIG. 8 is a diagram illustrating imaged structure portions calculated by an image area calculation unit in the data processing apparatus according to the first example embodiment;

FIG. 9 is a diagram illustrating a method of calculating the imaged structure portions in the data processing apparatus according to the first example embodiment;

FIG. 10 is a diagram illustrating the method of calculating the imaged structure portions in the data processing apparatus according to the first example embodiment;

FIG. 11 is a diagram illustrating a method of calculating visible structure portions in the data processing apparatus according to the first example embodiment;

FIG. 12 is a diagram illustrating the visible structure portions calculated by an image determination unit in the data processing apparatus according to the first example embodiment;

FIG. 13 is a diagram illustrating the imaged structure portions and the visible structure portions, in the data processing apparatus according to the first example embodiment;

FIG. 14 is a flowchart illustrating an outline of a data processing method according to the first example embodiment;

FIG. 15 is a flowchart illustrating a point group data display step in the data processing method according to the first example embodiment;

FIG. 16 is a flowchart illustrating an image data display step in the data processing method according to the first example embodiment; and

FIG. 17 is a diagram illustrating LiDAR as a point group data acquisition unit in a data processing system according to a second example embodiment.

### EXAMPLE EMBODIMENT

Some example embodiments are described below with reference to drawings. To clarify the description, the following description and the drawings are appropriately omitted and simplified. Further, in the drawings, the same elements are denoted by the same reference numerals, and repetitive descriptions are omitted as necessary.

(Outline of Example Embodiment)

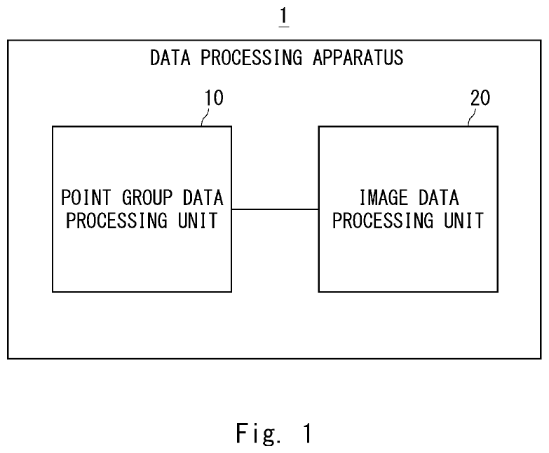

First, an outline of an example embodiment according to the present disclosure is described. FIG. 1 is a diagram illustrating an outline of a data processing apparatus according to the example embodiment.

As illustrated in FIG. 1, a data processing apparatus 1 includes a point group data processing unit 10 and an image data processing unit 20. The point group data processing unit 10 and the image data processing unit 20 have functions as a point group data processing means and an image data processing means, respectively. The data processing apparatus 1 handles, as a display object, a site including, for example, industrial facilities/equipment, common structures, a natural environment, and the like, processes point group data and image data on the display object, and displays the processed data on a GUI (Graphical User Interface) and the like. The display object is not limited to the industrial facilities/equipment and the like as long as the place includes the common structures, the natural environment, and the like, point group data and image data on which are acquirable. The display object may be commercial facilities/equipment, public facilities/equipment, or the like, and may be any structures and any natural environment. In the following, the display object is described as a “site”. When displaying the point group data and the image data on a measured object, the data processing apparatus 1 displays the point group data and the image data on a measurement object. Further, when displaying the point group data and the image data on a monitored object, the data processing apparatus 1 displays the point group data and the image data on a monitoring object.

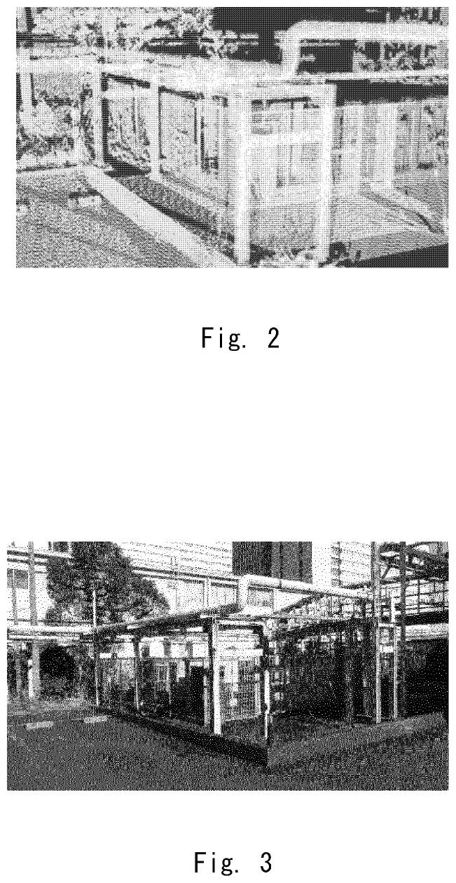

FIG. 2 is a diagram illustrating point group data displayed by the point group data processing unit 10 in the data processing apparatus 1 according to the example embodiment. FIG. 3 is a diagram illustrating image data displayed by the image data processing unit 20 in the data processing apparatus 1 according to the example embodiment. As illustrated in FIG. 2, when a viewpoint for display of point group data obtained by scanning the site is input, the point group data processing unit 10 displays the point group data viewed from the viewpoint. For example, when causing a point group viewer to display the point group data, the point group data processing unit 10 causes the point group viewer to display the site viewed from the input viewpoint.

On the other hand, as illustrated in FIG. 3, the image data processing unit 20 determines image data corresponding to the point group data to be displayed, from a plurality of pieces of image data obtained by imaging the site from different positions. The image data corresponding to the point group data to be displayed is, for example, image data including many imaging areas common to a display range of the point group data to be displayed. Thereafter, the image data processing unit 20 displays the determined image data. The image data processing unit 20 may display the determined image data alongside the point group data. For example, as illustrated in FIG. 2 and FIG. 3 arranged in a vertical direction, the point group data and the image data are displayed side by side in the vertical direction.

The display arrangement of the point group data and the image data is not limited to the arrangement in the vertical direction. The point group data processing unit 10 and the image data processing unit 20 may arrange and display the point group data and the image data in a horizontal direction, in an oblique direction inclined from the horizontal direction, or in a partially overlapping manner. Further, a lateral display size and a vertical display size of the image data may be different from a lateral display size and a vertical display size of the point group data. The arrangement direction, a size of the overlapping area, and the display size are not limited as long as the image data and the point group data are viewable together.

The image data processing unit 20 may display the image data in synchronization with a timing when the point group data processing unit 10 displays the point group data. For example, the image data processing unit 20 displays the image data at the same time when the point group data is displayed. The point group data processing unit 10 and the image data processing unit 20 may adjust timings when the point group data and the image data are displayed, by using a buffer or the like.

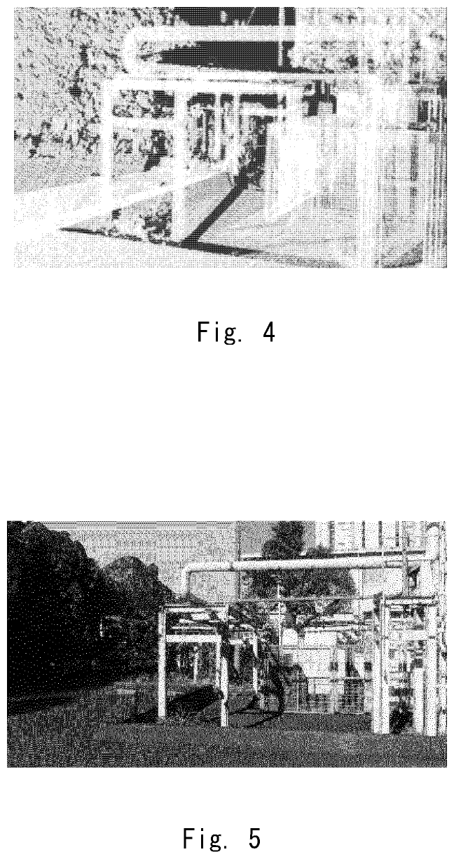

FIG. 4 is a diagram illustrating point group data displayed by the point group data processing unit 10 in a case where the viewpoint is moved, in the data processing apparatus 1 according to the example embodiment. FIG. 5 is a diagram illustrating image data displayed by the image data processing unit 20 in the case where the viewpoint is moved, in the data processing apparatus 1 according to the example embodiment. As illustrated in FIG. 4, in a case where a position of a viewpoint largely different from a sight line of the point group data illustrated in FIG. 2 is input, the point group data processing unit 10 displays point group data viewed from the newly-input viewpoint. In this case, as illustrated in FIG. 5, the image data processing unit 20 selects and determines image data corresponding to the point group data to be newly displayed, from the plurality of pieces of image data, and displays the determined image data alongside the point group data.

As described above, the data processing apparatus 1 according to the present example embodiment can display the image data corresponding to the display of the point group data. For example, the data processing apparatus 1 according to the present example embodiment can display the image data corresponding to the display of the point group data, alongside the point group data. This makes it possible to improve visibility of the point group data obtained by scanning the site and the image data obtained by imaging the site, and to improve browsability. Further, when the point group data is moved or rotated, the image data matching with the displayed point group data can be displayed. This makes it possible to improve convenience of the display of the point group data and the image data. Further, the timing when the point group data is displayed and the timing when the image data is displayed are synchronized with each other. This makes it possible to further improve visibility and browsability.

The data processing apparatus 1 may be configured by hardware including a microcomputer. The microcomputer includes, for example, a CPU (Central Processing Unit), a ROM (Read Only Memory), a RAM (Random Access Memory), and an interface unit (I/F). The CPU performs data processing such as calculation processing and control processing. The ROM stores data processing programs such as a calculation processing program and a control processing program to be executed by the CPU. The RAM stores various kinds of data such as point group data and image data. The interface unit (I/F) performs input/output of signals and data with outside. The CPU, the ROM, the RAM, and the interface unit are mutually connected through a data bus and the like.

### First Example Embodiment

### <Configuration of Data Processing Apparatus>

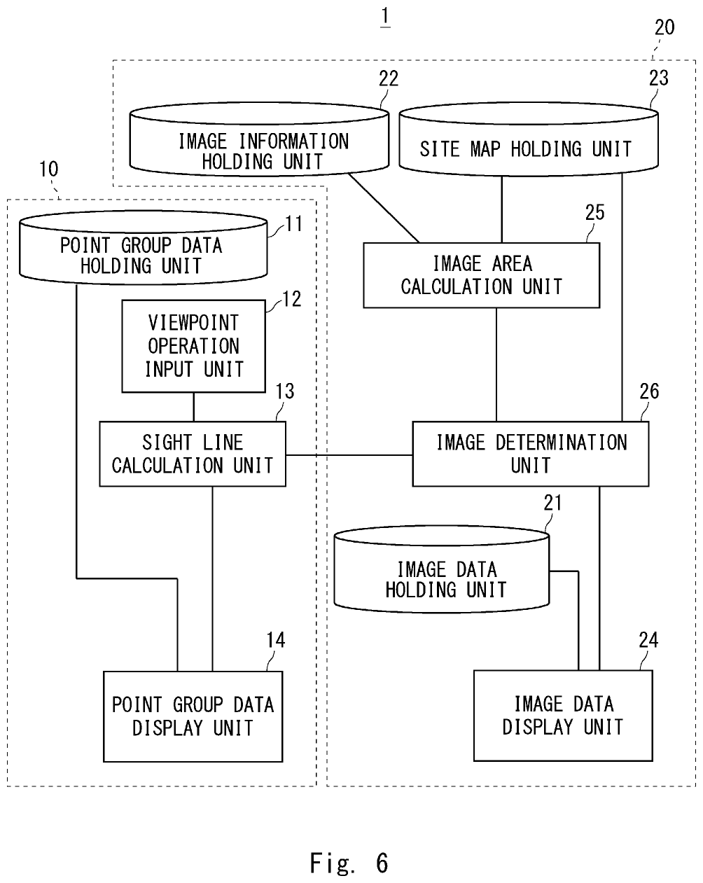

Next, details of the data processing apparatus 1 according to a first example embodiment are described. FIG. 6 is a configuration diagram illustrating the data processing apparatus 1 according to the first example embodiment.

As illustrated in FIG. 6, the point group data processing unit 10 includes a point group data holding unit 11, a viewpoint operation input unit 12, a sight line calculation unit 13, and a point group data display unit 14. The point group data holding unit 11, the viewpoint operation input unit 12, the sight line calculation unit 13, and the point group data display unit 14 have functions as a point group data holding means, a viewpoint operation input means, a sight line calculation means, and a point group data display means, respectively.

The point group data holding unit 11 holds the point group data obtained by scanning the site. The point group data holding unit 11 holds at least one piece of point group data obtained by scanning the site. The point group data is data indicating, for example, structures configuring the site as a group of a plurality of points each represented by a coordinate in a three-dimensional space. The point group data is obtained by, for example, measuring a distance from a predetermined position to an object. The point group data may be, for example, data on the site acquired by the LiDAR. Note that the point group data is not limited to the data acquired by the LiDAR, and may be data acquired by the other method of measuring the distance from the predetermined position to the object, for example, data acquired by a radar using radio waves. The point group data is displayed by using, for example, the point group viewer. The point group data holding unit 11 is connected to the point group data display unit 14, and outputs the point group data held by itself, to the point group data display unit 14.

The viewpoint operation input unit 12 receives input of a viewpoint for display of the point group data. A user who wants to display the point group data inputs the viewpoint for display of the point group data through the viewpoint operation input unit 12. The viewpoint operation input unit 12 is, for example, a keyboard, a mouse, an input unit of the point group viewer, or the like. The viewpoint operation input unit 12 is connected to the sight line calculation unit 13, and outputs the input viewpoint to the sight line calculation unit 13.

The sight line calculation unit 13 calculates sight line information including relationship between the input viewpoint and the point group data. The sight line information includes information on a position of the viewpoint for display of the point group data, and information on a direction, an orientation, and the like from the viewpoint to the point group data. The sight line calculation unit 13 is connected to the point group data display unit 14, and outputs the calculated sight line information to the point group data display unit 14. Further, the sight line calculation unit 13 is connected to an image determination unit 26, and outputs the calculated sight line information to the image determination unit 26.

The point group data display unit 14 displays the point group data viewed from the viewpoint, based on the calculated sight line information. The point group data display unit 14 is, for example, a GUI, and displays the point group data viewed from the viewpoint, to the user.

The image data processing unit 20 includes an image data holding unit 21, an image information holding unit 22, a site map holding unit 23, an image data display unit 24, an image area calculation unit 25, and the image determination unit 26. The image data holding unit 21, the image information holding unit 22, the site map holding unit 23, the image data display unit 24, the image area calculation unit 25, and the image determination unit 26 have functions as an image data holding means, an image information holding means, a site map holding means, an image data display means, an image area calculation means, and an image determination means, respectively.

The image data holding unit 21 holds a plurality of pieces of image data obtained by imaging the site from different positions. The image data may be color image data including RGB pixels, or gray-scale image data. The image data is image data captured by, for example, a camera. The image data holding unit 21 is connected to the image data display unit 24, and outputs the image data to the image data display unit 24.

The image information holding unit 22 holds imaging information on the plurality of pieces of image data held by the image data holding unit 21. The imaging information includes an imaging condition such as a position of the camera capturing the image data, posture of the camera, and an angle of view of the camera. The image information holding unit 22 is connected to the image area calculation unit 25, and outputs the imaging information held by itself, to the image area calculation unit 25.

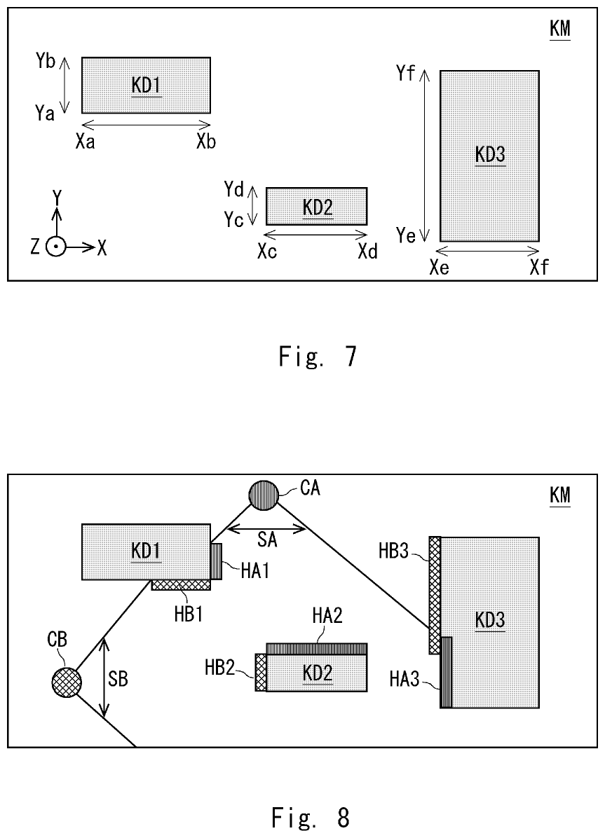

The site map holding unit 23 holds site information. The site information includes, for example, a structure map indicating layout of structures in the site, and structure data indicating positions of the structures disposed in the site. FIG. 7 is a diagram illustrating the structure map and the structure data held by the site map holding unit 23 in the data processing apparatus 1 according to the first example embodiment.

As illustrated in FIG. 7, a structure map KM indicates layout of structures KD1 to KD3 in the site. For example, in a case where the site is represented by XYZ orthogonal coordinate axes of a three-dimensional space, the structure map KM indicates that the three structures KD1 to KD3 provided in the site are disposed on an XY plane. On the other hand, the structure data indicates positions of the structures KD1 to KD3 disposed in the site. For example, the structure data indicates that the structure KD1 is positioned at coordinates (Xa to Xb, Ya to Yb). Note that a Z-axis coordinate is omitted. Likewise, the structure data indicates that the structure KD2 is positioned at coordinates (Xc to Xd, Yc to Yd), and the structure KD3 is positioned at coordinates (Xe to Xf, Ye to Yf).

The site map holding unit 23 may include site information other than the structure map KM and the structure data. For example, the site map holding unit 23 may hold site information such as a design drawing indicating the structures in the site. Further, the site map holding unit 23 may hold site information generated by a technique such as SLAM (Simultaneous Localization and Mapping) simultaneously performing self-position estimation and site map creation. The site map holding unit 23 is connected to the image area calculation unit 25, and outputs the site information held by itself, to the image area calculation unit 25. Further, the site map holding unit 23 is connected to the image determination unit 26, and outputs the site information held by itself to the image determination unit 26.

The image data display unit 24 displays the image data. For example, the image data display unit 24 displays the image data alongside the point group data. The image data to be displayed is image data determined by the image determination unit 26 described below. The image data display unit 24 may display the image data in synchronization with a timing when the point group data display unit 14 displays the point group data. In a case where a time difference occurs between display by the point group data display unit 14 and display by the image data display unit 24, the display timings may be adjusted. The image data display unit 24 is, for example, a GUI (Graphical User Interface), and presents the image data to the user.

The image area calculation unit 25 calculates imaged structure portions common to an imaging area of the site captured in the image data and the structure data indicating the positions of the structures KD1 to KD3 disposed in the site. A method of calculating the imaged structure portions is described below with reference to drawings.

FIG. 8 is a diagram illustrating imaged structure portions HA1 to HA3 and HB1 to HB3 calculated by the image area calculation unit 25 in the data processing apparatus 1 according to the first example embodiment. As illustrated in FIG. 8, to calculate the imaged structure portions HA1 to HA3 and HB1 to HB3, the image area calculation unit 25 first calculates imaging areas SA and SB on the structure map KM in the site information held by the site map holding unit 23, by using each imaging information held by the image information holding unit 22.

For example, the image area calculation unit 25 calculates the imaging area SA on the structure map KM by using imaging information on image data captured from an imaging position CA. Further, the image area calculation unit 25 calculates the imaging area SB on the structure map KM by using imaging information on image data captured from an imaging position CB. On the other hand, as described above, the structures KD1 to KD3 are disposed on the structure map KM in the site information.

The image area calculation unit 25 calculates the imaged structure portions HA1 to HA3 and HB1 to HB3 common to the plurality of imaging areas SA and SB calculated by using the imaging information, and the structure data held by the site map holding unit 23.

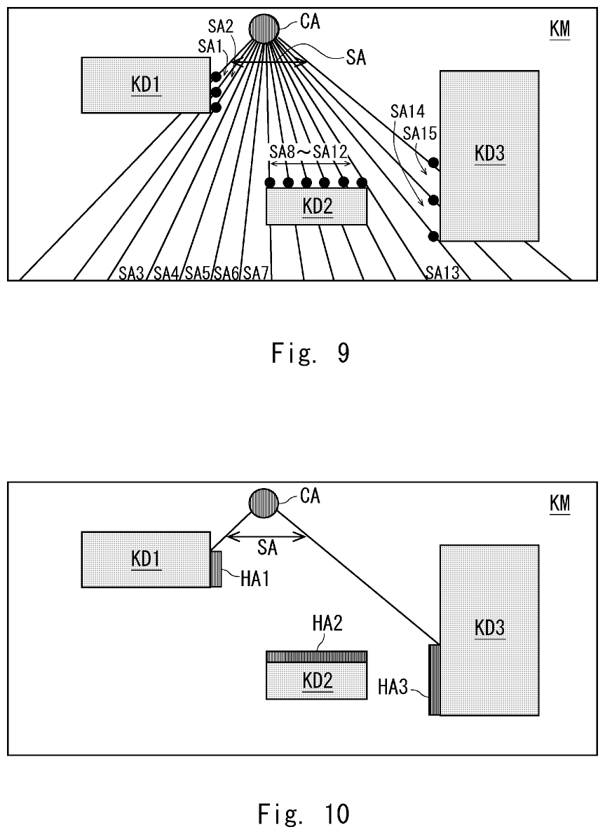

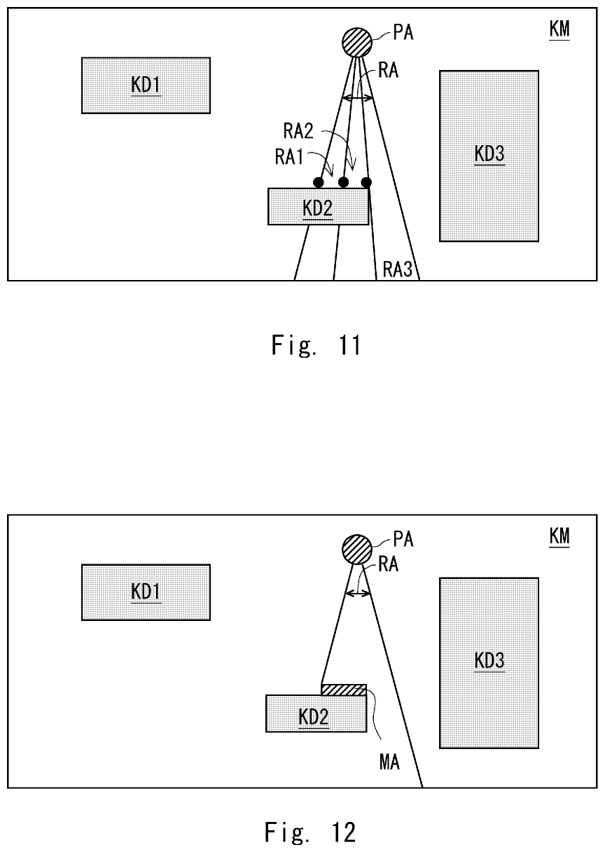

FIG. 9 and FIG. 10 are diagrams illustrating a method of calculating the imaged structure portions HA1 to HA3 and HB1 to HB3 in the data processing apparatus 1 according to the first example embodiment. As illustrated in FIG. 9, the image area calculation unit 25 calculates the imaging area SA on the structure map KM by using, for example, the angle of view and the imaging position among the imaging information held by the image information holding unit 22. Specifically, for example, the image area calculation unit 25 divides the angle of view into minute angles. Ranges captured in the respective minute angles correspond to minute imaging areas SA1 to SA15.

Further, the image area calculation unit 25 determines, among intersections between straight lines indicating boundaries of the minute angles and the structures KD1 to KD3 indicated by the structure data, intersections closest to the imaging position CA. In a case where the structure data is discrete data, a point at which a distance with any of the straight lines indicating the boundaries of the minute angles is less than or equal to a predetermined value may be regarded as an intersection. Among the acquired intersections, points close to one another are connected by a line. Portions each formed by the connected intersections correspond to the imaged structure portions HA1, HA2, and HA3. For example, the imaged structure portion HA1 includes minute imaging areas SA1 and SA2, the imaged structure portion HA2 includes minute imaging areas SA8 to SA12, and the imaged structure portion HA3 includes minute imaging areas SA14 and SA15.

As illustrated in FIG. 10, the image area calculation unit 25 calculates the imaged structure portions HA1 to HA3 in the above-described manner. As illustrated in FIG. 8, the image area calculation unit 25 calculates the imaged structure portions HB1 to HB3 for the image data captured from the imaging position CB. As described above, the image area calculation unit 25 calculates the plurality of imaging areas SA and SB on the structure map KM by using the plurality of pieces of imaging information, and calculates the imaged structure portions HA1 to HA3 and HB1 to HB3 by using the calculated imaging areas SA and SB. The image area calculation unit 25 is connected to the image determination unit 26, and outputs information including the calculated imaged structure portions HA1 to HA3 and HB1 to HB3 to the image determination unit 26.

When a viewpoint for display of the point group data obtained by scanning the site is input, the image determination unit 26 calculates visible structure potions common to visible areas facing the viewpoint side in the point group data and the structure data on the site. A method of calculating the visible structure portions is described below with reference to drawings.

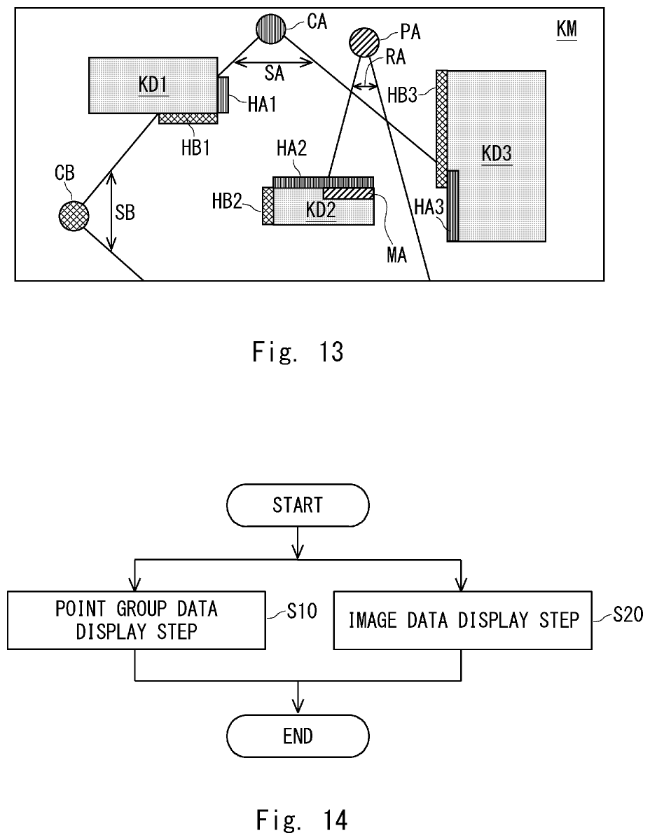

FIG. 11 is a diagram illustrating the method of calculating the visible structure portions in the data processing apparatus 1 according to the first example embodiment. FIG. 12 is a diagram illustrating the visible structure portions calculated by the image determination unit 26 in the data processing apparatus 1 according to the first example embodiment. As illustrated in FIG. 11, the image determination unit 26 calculates a visible area RA on the structure map KM by using the sight line information. For example, the image determination unit 26 calculates the visible area RA on the structure map KM by using sight line information in the point group data viewed from a viewpoint PA. Next, for example, the image determination unit 26 divides a view angle from the viewpoint PA into minute angles. Ranges viewable in the respective minute angles correspond to minute visible areas RA1 to RA3.

Thereafter, the image determination unit 26 determines, among intersections between straight lines indicating boundaries of the minute angles and the structures KD1 to KD3 indicated by the structure data, intersections closest to the viewpoint PA. In the case where the structure data is discrete data, a point at which a distance with any of the straight lines indicating the boundaries of the minute angles is less than or equal to a predetermined value may be regarded as an intersection. Among the acquired intersections, points close to one another are connected by a line. As a result, as illustrated in FIG. 12, a portion formed by the connected intersections corresponds to a visible structure portion MA. For example, the visible structure portion MA includes the minute imaging areas RA1 and RA2. The image determination unit 26 calculates the visible structure portion MA in the above-described manner.

FIG. 13 is a diagram illustrating the imaged structure portions HA1 to HA3 and HB1 to HB3 and the visible structure portion MA, in the data processing apparatus 1 according to the first example embodiment. As illustrated in FIG. 13, the image determination unit 26 determines image data to be displayed from the plurality of pieces of image data based on the imaged structure portion HA2 corresponding to the calculated visible structure portion MA. For example, the image determination unit 26 determines image data including the most imaged structure portions corresponding to the visible structure portion MA, as the image data to be displayed.

For example, in the example illustrated in FIG. 13, the image data captured from the imaging position CA includes the imaged structure portion HA2 corresponding to the visible structure portion MA. In contrast, the image data captured from the imaging position CB does not include the imaged structure portion corresponding to the visible structure portion MA. Accordingly, the image determination unit 26 determines, as the image data to be displayed, the image data captured from the imaging position CA among the plurality of pieces of image data. The image determination unit 26 is connected to the image data display unit 24, and outputs information on the determined image data to the image data display unit 24.

The image data display unit 24 displays the determined image data. The image data display unit 24 receives the determined image data from the image data holding unit 21 based on the information output from the image determination unit 26, and displays the image data. For example, as illustrated in FIG. 2 and FIG. 3, the image data display unit 24 displays the image data in synchronization with display of the point group data by the point group data display unit 14.

### <Outline of Data Processing Method>

Next, a data processing method using the data processing apparatus according to the first example embodiment is described. FIG. 14 is a flowchart illustrating an outline of the data processing method according to the first example embodiment.

As illustrated in FIG. 14, the data processing method according to the present example embodiment includes a point group data display step S10 of displaying the point group data, and an image data display step S20 of displaying the image data. In step S10, when the viewpoint for display of the point group data obtained by scanning the site is input, the point group data processing unit 10 displays the point group data viewed from the viewpoint as illustrated in FIG. 2 and FIG. 4.

Further, in step S20, the image data processing unit 20 determines image data corresponding to the point group data to be displayed, from the plurality of pieces of image data obtained by imaging the site from different positions, and displays the determined image data, as illustrated in FIG. 3 and FIG. 5. For example, the image data processing unit 20 displays the determined image data alongside the point group data. As a result, the image data corresponding to the display of the point group data can be displayed alongside the point group data. This makes it possible to display the image matching with the displayed point group data when the point group data is moved or rotated.

In the image data display step S20, the image data may be displayed in synchronization with a timing when the point group data is displayed. Specifically, the image data processing unit 20 may display the image data in synchronization with the display of the point group data by the point group data processing unit 10.

### <Point Group Data Display Step>

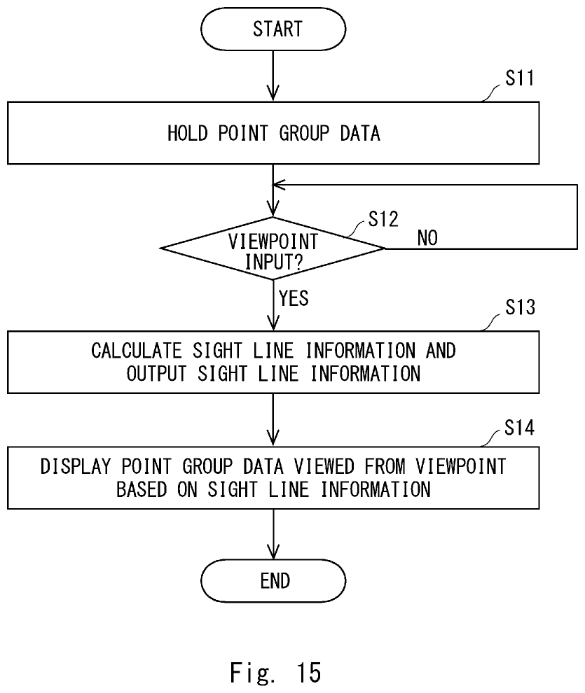

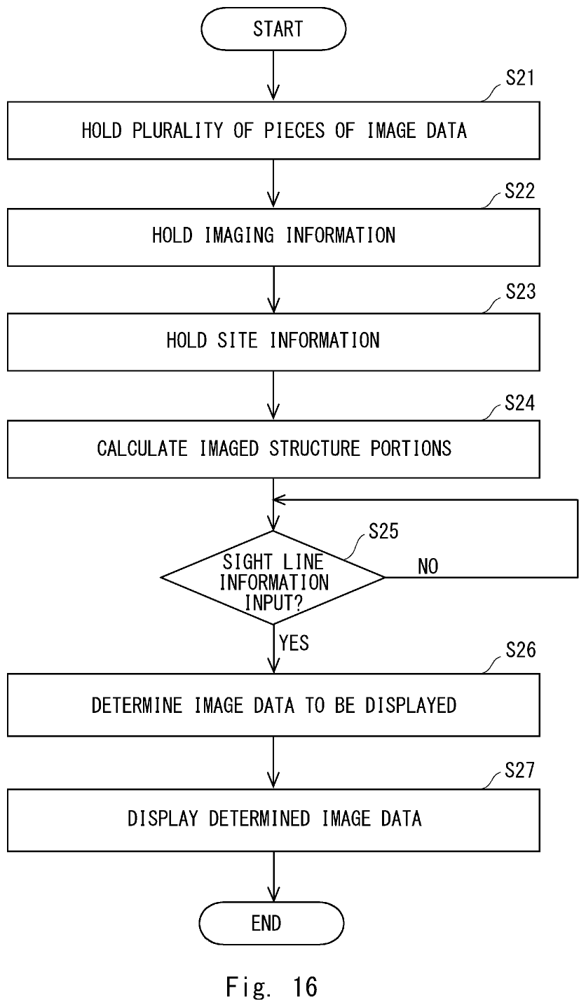

The data processing method according to the example embodiment is more specifically described below. First, the point group data display step S10 is described. FIG. 15 is a flowchart illustrating the point group data display step S10 in the data processing method according to the first example embodiment.

As illustrated in FIG. 15, the point group data display step S10 includes step S11 of holding the point group data, step S12 of determining whether the viewpoint has been input, step S13 of calculating and outputting sight line information, and step S14 of displaying the point group data viewed from the viewpoint based on the sight line information.

First, as illustrated in step S11, the point group data is held. For example, the point group data holding unit 11 holds the point group data obtained by scanning the site.

Next, as illustrated in step S12, it is determined whether the viewpoint PA has been input. For example, the viewpoint operation input unit 12 determines whether the viewpoint PA for display of the point group data has been input. In a case where the viewpoint PA has not been input in step S12, the processing waits as it is. In contrast, in a case where the viewpoint PA has been input in step S12, the viewpoint operation input unit 12 outputs the input viewpoint PA to the sight line calculation unit 13.

Next, as illustrated in step S13, the sight line information is calculated and the sight line information is output. For example, the sight line calculation unit 13 calculates the sight line information including relationship between the input viewpoint PA and the point group data. The sight line calculation unit 13 outputs the calculated sight line information to the point group data display unit 14. Further, the sight line calculation unit 13 outputs the calculated sight line information to the image determination unit 26.

Next, as illustrated in step S14, the point group data viewed from the viewpoint PA is displayed based on the calculated sight line information. For example, the point group data display unit 14 displays the point group data viewed from the viewpoint PA. The point group data display step S10 may further includes a step of acquiring the point group data before step S11 of holding the point group data. For example, the point group data display step S10 may include a step of acquiring the point group data on the site by the LiDAR.

### <Image Data Display Step>

Next, the image data display step S20 is described. FIG. 16 is a flowchart illustrating the image data display step S20 in the data processing method according to the first example embodiment.

As illustrated in FIG. 16, the image data display step S20 includes step S21 of holding the plurality of pieces of image data, step S22 of holding imaging information, step S23 of holding the site information, step S24 of calculating the imaged structure portions HA1 to HA3 and HB1 to HB3, step S25 of determining whether the sight line information has been input, step S26 of determining the image data to be displayed, and step S27 of displaying the determined image data.

First, as illustrated in step S21, the plurality of pieces of image data are held. For example, the image data holding unit 21 holds the plurality of pieces of image data obtained by imaging the site from different positions.

Next, as illustrated in step S22, the imaging information is held. For example, the image information holding unit 22 holds the imaging information including the imaging conditions of the plurality of pieces of image data held by the image data holding unit 21.

Next, as illustrated in step S23, the site information is held. For example, the site map holding unit 23 holds the site information including the structure map indicating layout of the structures in the site and the structure data indicating position of the structures disposed in the site. The order of step S21, step S22, and step S23 is not limited thereto. For example, the step of holding the plurality of pieces of image data may be performed in step S22 or step S23, and the step of holding the imaging information may be performed in step S21 or step S23. The step of holding the site information may be performed in step S21 or step S22.

Next, as illustrated in step S24, the imaged structure portions HA1 to HA3 and HB1 to HB3 are calculated. For example, the image area calculation unit 25 calculates the imaged structure portions HA1 to HA3 and HB1 to HB3 common to the imaging areas SA and SB of the site captured in the image data and the structure data indicating the positions of the structures disposed in the site. Specifically, the image area calculation unit 25 calculates the imaging areas SA and SB on the structure map of the site by using the imaging information. Further, the image area calculation unit 25 calculates the imaged structure portions HA1 to HA3 and HB1 to HB3 by using the calculated imaging areas SA and SB.

Next, as illustrated in step S25, it is determined whether the sight line information has been input. For example, the image determination unit 26 determines whether the sight line information has been input from the sight line calculation unit 13. In a case where the sight line information has not been input in step S25, the processing waits as it is.

In contrast, in a case where the sight line information has been input in step S25, the image data to be displayed is determined as illustrated in step S26. For example, the image determination unit 26 calculates the visible structure portion MA common to the visible area RA facing the viewpoint PA side in the point group data and the structure data. For example, the image determination unit 26 calculates the visible area RA on the structure map KM by using the sight line information input from the sight line calculation unit 13, and calculates the visible structure portion MA by using the calculated visible area RA.

Further, the image determination unit 26 determines the image data to be displayed among the plurality of pieces of image data based on the imaged structure portion HA2 corresponding to the calculated visible structure portion MA. At this time, the image determination unit 26 determines the image data including the most imaged structure portions corresponding to the visible structure portion RA, as the image data to be displayed.

Next, as illustrated in step S27, the determined image data is displayed. For example, the image data display unit 24 displays the determined image data alongside the point group data. The image data display unit 24 may display the image data in synchronization with the timing when the point group data is displayed. The data processing to display the point group data and the image data can be performed in the above-described manner.

Next, effects by the present example embodiment are described. In the data processing apparatus 1 according to the present example embodiment, the image data display unit 24 can display the image data corresponding to the display of the point group data by the point group data display unit 14. For example, the image data display unit 24 can display the image data alongside the point group data. This makes it possible to visibility of the point group data obtained by scanning the site and the image data obtained by imaging the site, and to improve browsability. Further, the image data is displayed in synchronization with the display of the point group data, which makes it possible to further improve visibility and browsability.

Further, when the viewpoint for the point group data is moved or rotated by the viewpoint operation input unit 12, the image data matching with the displayed point group data can be displayed. This makes it possible to improve convenience of the display of the point group data.

For example, Non-Patent Literature 1 discloses that the RGB information acquired by the camera is imparted to each point of the point group data and is displayed. In contrast, in the data processing apparatus 1 according to the present example embodiment, the point group data and the image data are separated and displayed side by side. Accordingly, the RGB information acquired by the camera is not imparted to the point group data, which enables coloring of the point group data based on the other information. Positional information, for example, can be displayed such that the point group data is colored to highlight an abnormal position in an inspection result.

Further, in the method disclosed in Non-Patent Literature 1, the RGB information is imparted to the point group data and is displayed. Therefore, it is not possible to acquire color information on a position such as a far place or sky where reflected light is not acquirable because irradiation light does not reach and point group data is not acquirable. In contrast, in the method according to the present example embodiment, the image data including the RGB information can be separately displayed alongside the point group data. Accordingly, it is possible to acquire color information on the position where the point group data is not acquirable.

### (First Modification)

Next, a modification of the first example embodiment is described. The image data display unit 24 may display three-dimensional image data constructed from the plurality of pieces of image data like an SFM (Structured from Motion) technique or the like. Specifically, the image data holding unit 21 holds three-dimensional image data on the site constructed from the plurality of pieces of image data. The image area calculation unit 25 calculates the imaged structure portions at each viewpoint position when the three-dimensional image data is viewed. The image determination unit 26 calculates the visible areas by using the sight line information, and determines the viewpoint position, the three-dimensional image data from which is displayed, based on the imaged structure portions corresponding to the calculated visible structure portions. As a result, the image data display unit 24 can display the three-dimensional image data from the determined viewpoint position.

According to the present modification, it is possible to continuously change the viewpoint position of the image data to be displayed. This makes it possible to improve similarity of the image data to be displayed, to the point group data, and to further improve visibility and convenience of the point group data and the image data.

### (Second Modification)

Next, a second modification of the first example embodiment is described. In the above-described first example embodiment, when determining the image data corresponding to the point group data to be displayed, the image determination unit 26 determines the image data to be displayed, based on the imaged structure portions corresponding to the visible structure portions. For example, the image determination unit 26 determines the image data including the most imaged structure portions corresponding to the visible structure portions, as the image data to be displayed. In the present modification, the image determination unit 26 determines the image data to be displayed, by using characteristic points of the point group data and characteristic points of the image data.

Specifically, the image data processing unit 20 includes the image determination unit 26 that determines the image data to be displayed from the plurality of pieces of image data based on characteristic points of the point group data to be displayed and characteristic points of the plurality of pieces of image data. The image determination unit 26 determines image data including the most characteristic points common to the characteristic points of the point group data to be displayed, as the image data to be displayed.

According to the present modification, since the image data to be displayed is determined by using the characteristic points of the point group data and the characteristic points of the image data, the image data to be displayed can be matched with the point group data to be displayed, and visibility and convenience of the point group data and the image data can be improved.

### Second Example Embodiment

Next, a data processing system according to a second example embodiment is described. The data processing system includes the above-described data processing apparatus 1 and a point group data acquisition unit acquiring the point group data. The point group data acquisition unit has a function as a point group data acquisition means. The point group data acquisition unit is, for example, the LiDAR. In this case, the point group data is data on the site acquired by the LiDAR. Further, the point group data acquisition unit may be, for example, flash LiDAR. In this case, the point group data is data acquired by the flash LiDAR at predetermined frequency. First, as the point group data acquisition unit, the LiDAR is described, and the flash LiDAR is then described.

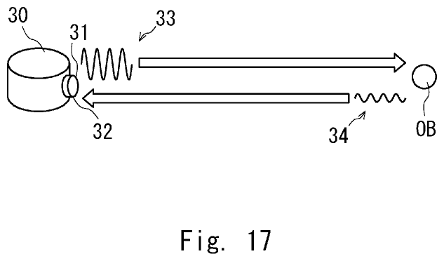

FIG. 17 is a diagram illustrating the LiDAR as the point group data acquisition unit in the data processing system according to the second example embodiment. As illustrated in FIG. 17, LiDAR 30 includes a light emission unit 31 and a detection unit 32. The light emission unit 31 emits irradiation light 33. The detection unit 32 detects reflected light 34 that is the irradiation light 33 reflected by an object OB. The LiDAR 30 scans the object OB with the irradiation light 33 at a predetermined angle of view. Further, the LiDAR 30 detects the reflected light 34 reflected by the object OB.

The LiDAR 30 calculates a distance D to the object OB from an expression D=(t2−t1)/2×(light velocity) by using a time t1 until the irradiation light 33 reaches the object OB and a time t2 until the reflected light 34 reaches the detection unit 32. As a result, the LiDAR 30 can acquire the point group data including the distance to the object OB as scan data in a scanned range.

The flash LiDAR acquires the point group data on the site at predetermined frequency. The point group data acquired by the flash LiDAR may be held by the point group data holding unit 11, or may be held by a memory provided in the flash LiDAR. The point group data display unit 14 acquires the point group data from the memory provided in the flash LiDAR in real time, and may display the acquired point group data.

Although the first and second example embodiments and the first and second modifications are described above, the present invention is not limited to the first and second example embodiments and the first and second modifications, and can be appropriately modified without departing from the spirit. For example, example embodiments obtained by combining the respective configurations of the first and second example embodiments and the first and second modifications are also included in the scope of the technical idea. Further, a data processing program causing a computer to execute the data processing method according to the first example embodiment is also included in the technical scope of the first and second example embodiments and the first and second modifications.

A part or all of the above-described example embodiments can be described as the following supplementary notes, but are not limited to the following description.

### (Supplementary Note 1)

A data processing apparatus, comprising:

a point group data processing means configured to display, when a viewpoint for display of point group data obtained by scanning a display object is input, the point group data viewed from the viewpoint; and

an image data processing means configured to determine image data corresponding to the point group data to be displayed, from a plurality of pieces of image data obtained by imaging the display object from different positions, and to display the determined image data.

### (Supplementary Note 2)

The data processing apparatus according to the supplementary note 1, wherein the data processing means displays the image data in synchronization with a timing when the point group data processing means displays the point group data.

### (Supplementary Note 3)

The data processing apparatus according to the supplementary note 1 or 2, wherein the image data processing means includes an image area calculation means configured to calculate imaged structure portions common to an imaging area of the display object captured in the image data and structure data indicating positions of structures disposed in the display object, and an image determination means configured to calculate visible structure portions common to visible areas facing the viewpoint side in the point group data and the structure data, and to determine the image data to be displayed, from the plurality of pieces of image data based on the imaged structure portions corresponding to the calculated visible structure portions.

### (Supplementary Note 4)

The data processing apparatus according to the supplementary note 3, wherein the image determination means determines the image data including the most imaged structure portions corresponding to the visible structure portions, as the image data to be displayed.

### (Supplementary Note 5)

The data processing apparatus according to the supplementary note 3 or 4, wherein the image data processing means includes an image data holding means configured to hold the plurality of pieces of image data, an image information holding means configured to hold imaging information including imaging conditions of the plurality of pieces of image data held by the image data holding means, a site map holding means configured to hold site information including the structure data, and an image data display unit configured to display the image data determined by the image determination means.

### (Supplementary Note 6)

The data processing apparatus according to the supplementary note 5, wherein the image area calculation means calculates the imaging area on a structure map indicating layout of the structures in the display object by using the imaging information, and calculates the imaged structure portions by using the calculated imaging area.

### (Supplementary Note 7)

The data processing apparatus according to any one of the supplementary notes 3 to 6, wherein the point group data processing means includes a point group data holding means configured to hold the point group data obtained by scanning the display object, a viewpoint operation input means configured to receive input of the viewpoint for display of the point group data, a sight line calculation means configured to calculate sight line information including relationship between the input viewpoint and the point group data, and a point group data display means configured to display the point group data viewed from the viewpoint based on the calculated sight line information.

### (Supplementary Note 8)

The data processing apparatus according to the supplementary note 7, wherein the image determination means calculates the visible areas on a structure map indicating layout of the structures in the display object by using the sight line information, and calculates the visible structure portions by using the calculated visible areas.

### (Supplementary Note 9)

The data processing apparatus according to any one of the supplementary notes 1 to 8, wherein the point group data is data on the display object acquired by LiDAR.

### (Supplementary Note 10)

A data processing system, comprising:

the data processing apparatus according to any one of the supplementary notes 1 to 9; and

a point group data acquisition means configured to acquire the point group data.

### (Supplementary Note 11)

A data processing method, comprising:

a point group data display step of displaying, when a viewpoint for display of point group data obtained by scanning a display object is input, the point group data viewed from the viewpoint; and

an image data display step of determining image data corresponding to the point group data to be displayed, from a plurality of pieces of image data obtained by imaging the display object from different positions, and displaying the determined image data.

### (Supplementary Note 12)

The data processing method according to the supplementary note 11, wherein, in the image data display step, the image data is displayed in synchronization with a timing when the point group data is displayed.

### (Supplementary Note 13)

The data processing method according to the supplementary note 11 or 12, wherein the image data display step includes a step of calculating imaged structure portions common to an imaging area of the display object captured in the image data and structure data indicating positions of structures disposed in the display object, and a step of calculating visible structure portions common to visible areas facing the viewpoint side in the point group data and the structure data, and determining the image data to be displayed, from the plurality of pieces of image data based on the imaged structure portions corresponding to the calculated visible structure portions.

### (Supplementary Note 14)

The data processing method according to the supplementary note 13, wherein, in the step of determining the image data to be displayed, the image data including the most imaged structure portions corresponding to the visible structure portions is determined as the image data to be displayed.

### (Supplementary Note 15)

The data processing method according to the supplementary note 13 or 14, wherein the image data display step further includes a step of holding the plurality of pieces of image data, a step of holding imaging information including imaging conditions of the plurality of pieces of held image data, a step of holding site information including the structure data, and a step of displaying the determined image data.

### (Supplementary Note 16)

The data processing method according to the supplementary note 15, wherein, in the step of calculating the imaged structure portions, the imaging area on a structure map indicating layout of the structures in the display object is calculated by using the imaging information, and the imaged structure portions are calculated by using the calculated imaging area.

### (Supplementary Note 17)

The data processing method according to any one of the supplementary notes 13 to 16, wherein the point group data display step includes a step of holding the point group data obtained by scanning the display object, a step of determining whether the viewpoint for display of the point group data has been input, a step of calculating sight line information including relationship between the input viewpoint and the point group data, and a step of displaying the point group data viewed from the viewpoint based on the calculated sight line information.

### (Supplementary Note 18)

The data processing method according to the supplementary note 17, wherein, in the step of determining the image data to be displayed, the visible areas on a structure map indicating layout of the structures in the display object is calculated by using the sight line information, and the visible structure portions are calculated by using the calculated visible areas.

### (Supplementary Note 19)

The data processing method according to any one of the supplementary notes 11 to 18, wherein the point group data is data on the display object acquired by LiDAR.

### (Supplementary Note 20)

The data processing method according to any one of the supplementary notes 11 to 19, further comprising a step of acquiring the point group data.

### (Supplementary Note 21)

A non-transitory computer-readable medium that stores a data processing program causing a computer to execute:

displaying, when a viewpoint for display of point group data obtained by scanning a display object is input, the point group data viewed from the viewpoint; and

determining image data corresponding to the point group data to be displayed, from a plurality of pieces of image data obtained by imaging the display object from different positions, and displaying the determined image data.

### (Supplementary Note 22)

The non-transitory computer-readable medium that stores the data processing program according to the supplementary note 21, in which the data processing program causes the computer to execute, when the determined image data is displayed, displaying the image data in synchronization with a timing when the point group data is displayed.

### (Supplementary Note 23)

The non-transitory computer-readable medium that stores the data processing program according to the supplementary note 21 or 22, in which the data processing program causes the computer to execute, when the determined image data is displayed, calculating imaged structure portions common to an imaging area of the display object captured in the image data and structure data indicating positions of structures disposed in the display object, and calculating visible structure portions common to visible areas facing the viewpoint side in the point group data and the structure data, and determining the image data to be displayed, from the plurality of pieces of image data based on the imaged structure portions corresponding to the calculated visible structure portions.

### (Supplementary Note 24)

The non-transitory computer-readable medium that stores the data processing program according to the supplementary note 23, in which the data processing program causes the computer to execute, when the image data to be displayed is determined, determining the image data including the most imaged structure portions corresponding to the visible structure portions, as the image data to be displayed.

### (Supplementary Note 25)

The non-transitory computer-readable medium that stores the data processing program according to the supplementary note 23 or 24, in which the data processing program causes the computer to execute, when the determined image is displayed, holding the plurality of pieces of image data, holding imaging information including imaging conditions of the plurality of pieces of held image data, holding site information including the structure data, and displaying the determined image data.

### (Supplementary Note 26)

The non-transitory computer-readable medium that stores the data processing program according to the supplementary note 25, in which the data processing program causes the computer to execute, when the imaged structure portions are calculated, calculating the imaging area on a structure map indicating layout of the structures in the display object by using the imaging information, and calculating the imaged structure portions by using the calculated imaging area.

### (Supplementary Note 27)

The non-transitory computer-readable medium that stores the data processing program according to any one of the supplementary notes 13 to 16, in which the data processing program causes the computer to execute, when the point group data viewed from the viewpoint is displayed, holding the point group data obtained by scanning the display object, determining whether the viewpoint for display of the point group data has been input, calculating sight line information including relationship between the input viewpoint and the point group data, and displaying the point group data viewed from the viewpoint based on the calculated sight line information.

### (Supplementary Note 28)

The non-transitory computer-readable medium that stores the data processing program according to the supplementary note 27, in which the data processing program causes the computer to execute, when the image data to be displayed is determined, calculating the visible areas on a structure map indicating layout of the structures in the display object by using the sight line information, and calculating the visible structure portions by using the calculated visible areas.

### (Supplementary Note 29)

The non-transitory computer-readable medium that stores the data processing program according to any one of the supplementary notes 21 to 28, in which the point group data is data on the display object acquired by LiDAR.

### (Supplementary Note 30)

The non-transitory computer-readable medium that stores the data processing program according to any one of the supplementary notes 21 to 29, in which the data processing program causes the computer to execute acquiring the point group data.

In the above-described examples, the program can be stored by using various types of non-transitory computer-readable media, and supplied to a computer. The non-transitory computer-readable media include various types of tangible storage media. Examples of the non-transitory computer-readable media include a magnetic recording medium (for example, flexible disk, magnetic tape, and hard disk drive), a magnetooptical recording medium (for example, magnetooptical disk), a CD-ROM (Read Only Memory), a CD-R, a CD-R/W, and a semiconductor memory (for example, mask ROM, PROM (Programmable ROM), EPROM (Erasable PROM), flash ROM, and RAM (Random Access Memory)). Further, the program may be supplied to the computer by various types of transitory computer readable media. Examples of the transitory computer readable media include an electric signal, an optical signal, and an electromagnetic wave. The transitory computer readable media can supply the program to the computer through a wired communication channel such as an electric cable and an optical fiber, or a wireless communication channel.

### REFERENCE SIGNS LIST

1 DATA PROCESSING APPARATUS
10 POINT GROUP DATA PROCESSING UNIT
11 POINT GROUP DATA HOLDING UNIT
12 VIEWPOINT OPERATION INPUT UNIT
13 SIGHT LINE CALCULATION UNIT
14 POINT GROUP DATA DISPLAY UNIT
20 IMAGE DATA PROCESSING UNIT
21 IMAGE DATA HOLDING UNIT
22 IMAGE INFORMATION HOLDING UNIT
23 SITE MAP HOLDING UNIT
24 IMAGE DATA DISPLAY UNIT
25 IMAGE AREA CALCULATION UNIT
26 IMAGE DETERMINATION UNIT
30 LiDAR
31 LIGHT EMISSION UNIT
32 DETECTION UNIT
33 IRRADIATION LIGHT
34 REFLECTED LIGHT
CA, CB IMAGING POSITION
HA1, HA2, HA3, HB1, HB2, HB3 IMAGED STRUCTURE PORTION
KD1, KD2, KD3 STRUCTURE
MA VISIBLE STRUCTURE PORTION
RA VISIBLE AREA
SA, SBIMAGING AREA

What is claimed is:

1. A data processing apparatus, comprising:
a point group data processing unit configured to display, when a viewpoint for display of point group data obtained by scanning a display object is input, the point group data viewed from the viewpoint; and
an image data processing unit configured to determine image data corresponding to the point group data to be displayed, from a plurality of pieces of image data obtained by imaging the display object from different positions, and to display the determined image data.

2. The data processing apparatus according to claim 1, wherein the data processing unit displays the image data in synchronization with a timing when the point group data processing means displays the point group data.

3. The data processing apparatus according to claim 1, wherein the image data processing unit includes an image area calculation unit configured to calculate imaged structure portions common to an imaging area of the display object captured in the image data and structure data indicating positions of structures disposed in the display object, and an image determination unit configured to calculate visible structure portions common to visible areas facing the viewpoint side in the point group data and the structure data, and to determine the image data to be displayed, from the plurality of pieces of image data based on the imaged structure portions corresponding to the calculated visible structure portions.

4. The data processing apparatus according to claim 3, wherein the image determination means unit determines the image data including the most imaged structure portions corresponding to the visible structure portions, as the image data to be displayed.

5. The data processing apparatus according to claim 3, wherein the image data processing unit includes an image data holding unit configured to hold the plurality of pieces of image data, an image information holding unit configured to hold imaging information including imaging conditions of the plurality of pieces of image data held by the image data holding unit, a site map holding unit configured to hold site information including the structure data, and an image data display unit configured to display the image data determined by the image determination unit.

6. The data processing apparatus according to claim 5, wherein the image area calculation means unit calculates the imaging area on a structure map indicating layout of the structures in the display object by using the imaging information, and calculates the imaged structure portions by using the calculated imaging area.

7. The data processing apparatus according to claim 3, wherein the point group data processing unit includes a point group data holding unit configured to hold the point group data obtained by scanning the display object, a viewpoint operation input means configured to receive input of the viewpoint for display of the point group data, a sight line calculation unit configured to calculate sight line information including relationship between the input viewpoint and the point group data, and a point group data display means configured to display the point group data viewed from the viewpoint based on the calculated sight line information.

8. The data processing apparatus according to claim 7, wherein the image determination unit calculates the visible areas on a structure map indicating layout of the structures in the display object by using the sight line information, and calculates the visible structure portions by using the calculated visible areas.

9. The data processing apparatus according to claim 1, wherein the point group data is data on the display object acquired by LiDAR.

10. A data processing system, comprising:
the data processing apparatus according to claim 1; and
a point group data acquisition unit configured to acquire the point group data.

11. A data processing method, comprising:
a point group data display step of displaying, when a viewpoint for display of point group data obtained by scanning a display object is input, the point group data viewed from the viewpoint; and
an image data display step of determining image data corresponding to the point group data to be displayed, from a plurality of pieces of image data obtained by imaging the display object from different positions, and displaying the determined image data.

12. The data processing method according to claim 11, wherein, in the image data display step, the image data is displayed in synchronization with a timing when the point group data is displayed.

13. The data processing method according to claim 11, wherein the image data display step includes a step of calculating imaged structure portions common to an imaging area of the display object captured in the image data and structure data indicating positions of structures disposed in the display object, and a step of calculating visible structure portions common to visible areas facing the viewpoint side in the point group data and the structure data, and determining the image data to be displayed, from the plurality of pieces of image data based on the imaged structure portions corresponding to the calculated visible structure portions.

14. The data processing method according to claim 13, wherein, in the step of determining the image data to be displayed, the image data including the most imaged structure portions corresponding to the visible structure portions is determined as the image data to be displayed.

15. The data processing method according to claim 13, wherein the image data display step further includes a step of holding the plurality of pieces of image data, a step of holding imaging information including imaging conditions of the plurality of pieces of held image data, a step of holding site information including the structure data, and a step of displaying the determined image data.

16. The data processing method according to claim 15, wherein, in the step of calculating the imaged structure portions, the imaging area on a structure map indicating layout of the structures in the display object is calculated by using the imaging information, and the imaged structure portions are calculated by using the calculated imaging area.

17. The data processing method according to claim 13, wherein the point group data display step includes a step of holding the point group data obtained by scanning the display object, a step of determining whether the viewpoint for display of the point group data has been input, a step of calculating sight line information including relationship between the input viewpoint and the point group data, and a step of displaying the point group data viewed from the viewpoint based on the calculated sight line information.

18. The data processing method according to claim 17, wherein, in the step of determining the image data to be displayed, the visible areas on a structure map indicating layout of the structures in the display object is calculated by using the sight line information, and the visible structure portions are calculated by using the calculated visible areas.

19. The data processing method according to claim 11, wherein the point group data is data on the display object acquired by LiDAR.

20. The data processing method according to claim 11, further comprising a step of acquiring the point group data.
